(19) United States
(12) Patent Application Publication
(10) Pub. No.: US 2009/0175125 A1
(43) Pub. Date: Jul. 9, 2009

(54) Direct Mapping of Oil-Saturated Subsurface Formations

(75) Inventors: Tawassul Ali Khan, Cypress, TX (US); Sofia Khan McGuire, Houston, TX (US)

Correspondence Address: NONLINEAR SEISMIC IMAGING, INC., 12639 RIFLEMAN TRAIL, CYPRESS, TX, 77429, US

(73) Assignee: NONLINEAR SEISMIC IMAGING, INC., Cypress, TX (US)

(21) Appl. No.: 11/968,688

(22) Filed: Jan. 3, 2008

(51) Int. Cl. G01V 1/34

(52) U.S. Cl. 367/43

(57) ABSTRACT

The propagation of a compressional wave in a reservoir rock causes the pore fluids to flow within the pores and pore connections; this internal flow of the pore fluid exhibits hysteretic and viscoelastic behavior. This nonlinear behavior is directly related to the viscosity of the pore fluids. Pore fluids that have higher viscosity like oil, after being disturbed due to a sudden change in pressure applied by a seismic impulse, require a larger time-constant to return to its original state of equilibrium. This larger time-constant generates lower seismic frequencies, and becomes the differentiating characteristic on a seismic image between the lower-viscosity pore fluid like water against the higher-viscosity pore fluid like oil. Mapping these lower frequencies on a seismic reflection image highlights the oil-bearing volume of the reservoir rock formations versus the volume of the reservoir rock formations saturated with water or gas.

### BACKGROUND OF THE INVENTION

1. Field of Invention

This invention is related to mapping and highlighting on a seismic reflection image, reservoir formations that have higher-viscosity pore fluids like oil, in comparison with reservoir formations that have lower viscosity pore fluids like water and gas. Oil, the higher-viscosity pore fluid, requires more time to go back to its original equilibrium state after the pore fluid has been disturbed by a seismic compressional impulse. The time required to recover to the state of equilibrium after the reservoir rock has been deformed as a result of being exposed to an outside seismic impulse can be identified as a time-constant. The recovery time response, known as time-constant, required to reach the state of equilibrium is greater in the case of oil as a pore fluid, versus water or gas. The time-constant, which represents the decay of the stored potential energy in the pore fluids, generates lower frequencies. More specifically, this invention describes a method of identifying oil-saturated rocks by mapping the lower frequencies in the seismic spectrum. These lower frequencies are generated in the reservoir rocks due to the relative movement between the oil and the rock matrix. These lower frequencies will not be present in the case of water or gas, which have a much lower time-constant. Mapping the presence or absence of these lower frequencies becomes a powerful seismic attribute to locate the oil-bearing formations.

2. Description of the Related Art

At present, seismic reflection methods are universally being used to map the structure of the subsurface formations. The mapped structural information delineates the possible hydrocarbon traps that can be drilled. However, due to the complexity of the sedimentary rocks, it becomes difficult to rely on current seismic data to identify and map the reservoir properties prior to drilling the location of interest. Ideally, one would like to identify the presence and the type of pore fluids, and to determine their location and their extent. Using current seismic methods, it is difficult to extract that type of reservoir information since the only known parameters are velocity, attenuation and modulus. To extract information like reservoir pore fluids, porosity and permeability, one finds that there are more unknown parameters than known parameters in the equations used to resolve them, which causes a great deal of ambiguity in the seismic results. The common product of any set of seismic reflection data is acoustic impedance, which in turn depends on several rock properties including velocity, density, porosity, differential pressure, rock matrix, pore fluids, and fluid compressibility. With that many unknowns and not enough equations to solve them, it becomes obvious that there are problems that one faces when one tries to extract reservoir properties from the seismic reflection data. Subjective decisions are made, which may not represent the reality of the complex subsurface.

At times, S-wave (shear wave) recordings are carried out in addition to P-wave (compressional wave) recordings. This provides additional information to reduce the ambiguity of the results. However, S-wave seismic sources are not available in the market, and industry has to rely on mode-converted shear waves generated at the boundaries of the formations, which have different elastic properties. In areas that have complex geology and structural geometry, it becomes difficult to identify and process mode converted S-waves, since mode conversions from P to S-wave and vice-versa take place in a very unpredictable manner. Even in the case where data is well behaved and P and S-wave velocities can be derived, it is difficult to map certain rock properties like porosity and clay content due to a certain amount of self-similarity between the behaviors of the two waves.

To reduce the level of ambiguity and the risk associated with hydrocarbon exploration, seismic technology known as amplitude-variance-with-offset (AVO) has been introduced. The AVO anomaly is most commonly expressed as an increase in the reflection amplitude with the increase in offset distance. AVO has a reasonable chance of success in mapping gaseous hydrocarbon traps. However, like every technology, it has its own shortcomings. AVO has not been successful in Gulf of Mexico, where the sands are calcium carbonate-cemented, or in the Denver-Julesburg basin and Sacramento Valley. At present the success rate of AVO is claimed to be better than fifty percent.

Recently electromagnetic (EM) methods have been re-introduced to reduce the uncertainty of the seismic results prior to drilling commitment. Lately, controlled source electromagnetic technology (CSEM) has been used in deep water to reduce the risk of drilling expensive wells. The value of CSEM has been to complement the seismic data with direct detection of hydrocarbons in the subsurface. The basic concept of the technology is to measure the resistivity of the subsurface structure. Hydrocarbon-filled reservoirs show higher resistivity compared to water-filled reservoirs. This technology is still in its development stage and may prove to be very useful in the future. However, it is not a stand-alone technology and has to be integrated with reflection seismic to provide meaningful results. The resolution of EM technology is limited; the individual formations, which are oil-saturated, cannot be mapped nor their areal extent accurately defined.

At present, using currently available subsurface imaging methods, seismic or otherwise, more than 60% of the producible oil has been left behind in the reservoirs. The extraction technologies exist; however, the weakness in detecting oil is the lack of reliable subsurface imaging methods to identify the pockets of residual oil left unproduced. The oil industry needs a paradigm shift and needs to recognize that there has to be a greater focus on mapping and distinguishing the actual reservoir properties instead of the rock properties. Rock properties constitute mapping changes in velocity and amplitude anomalies due to changes in reservoir characteristics. Reservoir properties are more closely related to pore structure, pore connections, pore fluids and their flow characteristics. These properties can be better mapped by inventing and introducing new seismic methods that relate to the nonlinear characteristics of the reservoir rocks, which are related physically to the interaction between the rock matrix and the reservoir fluids as a result of the rock being excited by the controlled seismic signals.

The current seismic practice has made an incorrect assumption of elastic linearity, when dealing with the seismic wave propagation in the reservoir rocks. At present, the seismic industry generally ignores the effects of elastic nonlinearity in the reservoir rocks, which is the most important and differentiating characteristic in identifying the porous permeable and fluid-saturated subsurface formations. This simplified assumption of linearity is quite often based on convenience and to avoid complex and cumbersome mathematics necessary to deal with the nonlinear behavior. Implicit in the assumption of elastic linearity is the fact that the seismic wave or pulse recorded after being reflected or refracted will contain only those frequencies that were part of the original seismic input signal. In the assumption of an elastically linear system, no new frequencies can be generated while the seismic signal is traveling through different earth formations. This approach has shut the door for new developments that could resolve many of the current seismic imaging problems.

Most seismic recordings for hydrocarbon exploration are made with a useable bandwidth of 6 Hz to 8 Hz on the lower end of the seismic frequency spectrum and 70 Hz to 80 Hz on the upper end of the frequency spectrum. The current seismic recording practices are designed for a linear earth model that has been successful for mapping subsurface structure but has not been very effective in mapping reservoir properties like porosity, permeability and pore fluids. Elastic nonlinearity effects in a porous and permeable reservoir rock generate new frequencies that may be as low as 1 Hz or 2 Hz, and could be used as an indicator of higher-viscosity pore fluid like oil. To achieve that, seismic data has to be recorded with a bandwidth that has lower frequencies all the way down to 0 Hz. The current seismic is more suitable for mapping structural details of the subsurface formations, but has serious limitations when trying to extract reservoir properties from the seismic data.

### SUMMARY OF THE INVENTION

For years, the oil industry has been searching for a technology that will enable it to map subsurface reservoirs that hold oil rather than water or gas. So far, there has not been any significant breakthrough. One of the physical characteristics of the oil is its higher viscosity, which differentiates it from water and gas. This invention uses this higher viscosity, which is oil's differential physical characteristic, to seismically map the oil-bearing subsurface reservoir rocks and highlight them on seismic subsurface reflection images in comparison with lower viscosity water-saturated or gas-saturated rocks.

The presence of the pores and pore fluids, which occupy a significant volume of the reservoir rocks, have a pronounced effect on their dynamic elastic properties. When a seismic impulse is applied to the reservoir rock, there is a local change in its volume, density, and modulus. During the compression cycle of the impulse, the volume of the rock is reduced. In response to the sudden pressure and volume change, the internal flow of the pore fluids takes place in the case of the porous and permeable reservoir rock. This internal flow of the pore fluids causes a part of the energy to be dissipated due to friction, and the remainder is stored in the form of potential energy due to the displacement of the pore fluids. This component of the potential energy, which is stored in the displaced pore fluid, tends to restore the original state of equilibrium, which has been disturbed. The process of restoration, which involves the pore fluids to go back to their original state of equilibrium, requires a certain period of time interval. The recovery time response is related to the viscosity of the pore fluid and the physical geometry of the pores and their interconnections. In the case of water and gas, which have lower viscosity, the restoring time-constant is lower in comparison with oil, which has higher viscosity. Higher-viscosity fluid like oil, shows relatively higher resistance to flow and consequently requires more time to find its state of equilibrium after the pore fluids have been disturbed.

Once an object displaying an elastic characteristic is distorted, its shape tends to be restored to its original equilibrium state. In the same manner, when the pore fluids in the reservoir rocks are forced to move in response to a seismic impulse, the fluids tend to go back to their original state of equilibrium. This recovery to their original state of equilibrium is time-dependent on the flow characteristics of the pore fluids, mainly its viscosity and the shape of the pores and their interconnections. The elastic behavior of the rock matrix and the pore fluids is physically coupled. The energy dissipation and the potential energy stored in the pore fluids due to their movement caused by a seismic impulse directly affects the elastic property of the reservoir rock. The elastic behavior of the reservoir rock, saturated with high-viscosity pore fluid like oil, will be different than the reservoir rock saturated with water or gas. After a seismic impulse has been applied, the restoring time-constant of the oil-saturated reservoir rock will be larger compared to the restoring time-constant of the reservoir rock saturated with water or gas.

The larger time-constant stretches the waveform of the seismic impulse and generates lower frequencies that are not part of the seismic input signal. The higher-viscosity pore fluids like oil cause more pulse stretching since they exhibit a larger time-constant. Consequently, more pronounced lower frequencies are generated when a seismic pulse propagates through an oil-saturated reservoir compared to when the same formation is saturated with water or gas.

This invention provides a method for seismic reflection mapping the location and the extent of the oil-bearing reservoir formations. The measurement of the relative amplitudes of the lower frequencies in the seismic spectrum of a particular subsurface horizon, which are in the order of 2 Hz to 6 Hz, is a strong indicator of the presence of high-viscosity pore fluid like oil. The dominance of the relative amplitudes of these lower frequencies in the seismic-reflected signals of a particular subsurface formation is indicative that these frequencies are being generated in that particular reservoir formation. By mapping and displaying the subsurface seismic reflection image using various frequency filtering methods available in the industry today, one can highlight the oil-bearing rocks and identify their location and extent. This method of mapping oil-bearing subsurface formations is equally applicable for land or marine operations. According to the current and accepted art, surface or borehole seismic can be used for the method described in this invention. To provide more distinct identification of the frequencies being generated in the oil-saturated reservoir rock against the seismic source-generated frequencies, the seismic source has to generate a short duration impulse that is rich in frequencies above 10 Hz, and weak in generating frequencies below 6 Hz. This is not a major problem since most land and marine seismic sources currently being used are designed to generate higher frequencies to provide a higher resolution subsurface image and lack the lower-frequency component in their output.

This invention will help simplify the whole process of oil exploration by improving the reliability of the seismic results. This invention provides a method of direct oil detection in the subsurface formations, and of mapping the location and extent of the oil-bearing rocks.

### BRIEF DESCRIPTION OF THE DRAWINGS

FIG. 1 is a simplified schematic, taken partly in cross section, to illustrate different onshore (land) configurations of the field data acquisition for the invention.

FIG. 2 is another version of a simplified schematic that illustrates different offshore configurations of the field data acquisition for the invention.

FIG. 3 illustrates the squirt flow of the pore fluids due to the deformation of the rock matrix due to compression caused by a seismic impulse.

FIG. 4 illustrates the time-constant or the recovery time response for different type of fluids to acquire the state of equilibrium after the seismic disturbance.

FIG. 5 illustrates the spectral response of different viscosity pore fluids after a seismic impulse has been applied.

### DESCRIPTION OF THE PREFERRED EMBODIMENT

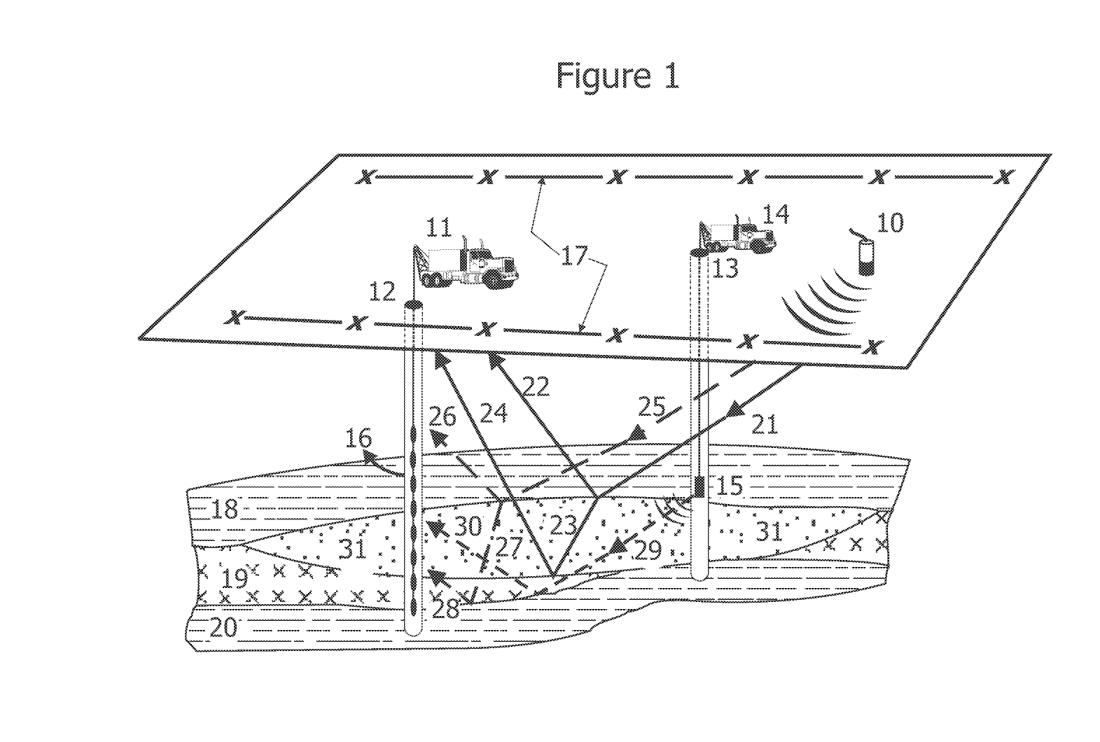

In the drawings, FIG. 1 schematically illustrates the concept of different configurations of land seismic field recording methods for this invention. This invention relates to different methods of seismic recording for mapping oil-bearing subsurface reservoir rocks. To improve the economics of hydrocarbon exploration, it is important to know if the subsurface reservoir rocks are oil-saturated or water-saturated. To drill on a seismic anomaly and find that there is no oil is expensive and a waste of exploration effort.

At present, seismic surveys are recorded to map the subsurface structural anomalies and decisions are made based on this information. To improve the reliability of the results, further analysis is carried out based on the variations in amplitude and velocities. The major shortcoming of the current seismic imaging methods that are currently being used is that none of them can identify the presence or absence and the type of reservoir fluids with any certainty. Seismic data are acquired using surface sources and surface receivers, surface sources and downhole receivers, downhole sources and downhole receivers or any combination of the data acquisition techniques.

This invention analyzes the modifications in the frequency spectrum of the seismic input impulse in the form of additional frequencies being generated and added to the spectrum. The generation of these new frequencies takes place during the propagation of the seismic impulse through a reservoir rock that is oil-saturated or water-saturated. In response to the compressional impulse, which causes a volume change of the reservoir rock, pore fluids are squirted out of the pore interconnections and the equilibrium state of the reservoir rock gets disturbed. During the time that follows the compressional cycle of the seismic impulse, the pore fluids and the rock matrix tend to go back to their original state of equilibrium. Due to the different viscosities of the pore fluids, the time taken to recover back to the original state varies. This time of recovery can be identified as a ‘time-constant’. Higher-viscosity pore fluids like oil require a larger recovery time-constant compared to water or gas that have lower viscosity, hence a lower recovery time-constant. A larger time-constant causes the seismic pulse to stretch in time and generates lower frequencies that are not present in the original seismic input signal.

FIG. 1 illustrates different methods of land seismic reflection recording that can be used for this invention. A surface source 10 generates a short duration seismic impulse. It can be an explosive charge in a shot hole or an impact on the ground surface, these methods are generally known and used in the industry. The reflected seismic signals that are generated due to the reflected energy from the subsurface acoustic impedance contrast are recorded by the surface receiver arrays 17 or downhole array 16 located in well 12, or any combination of the two. The received reflected seismic signals are recorded by seismic instruments, which are housed in the recording truck 11. The seismic reflection recording of the reservoir formations can also be made using a downhole source 15 located in well 13. The reflected signals from the reservoir formations can be recorded by the receiver array 16 or the surface array 17. The recording truck 11 is capable of recording simultaneously data from surface array 17 and downhole array 16. This data acquisition as shown in FIG. 1 can be done using current available equipment in the industry and the recording methods are well understood and currently in use by the industry. Deployment of the downhole source is done using a standard wireline truck 14, which can deploy and energize the downhole source 15, according to the known and established current art. At present, downhole air guns are available that can generate the desired short duration seismic impulse to be used for this invention. Basically FIG. 1 is illustrating that there are many surface and borehole seismic reflection methods currently being used, and this invention is equally applicable to all of them.

FIG. 1 shows subsurface formations 18, 19, and 20 in cross section. Formation 19 is the reservoir rock that has porosity, permeability and pore fluids. The formations 18 and 20 are sealing formations with little porosity and no permeability. The formation 19 is saturated with oil in the upper part of the formation shown as 31, which forms a small anticline. The rest of the formation 19 is water-saturated. The propagation of a compressional seismic impulse deforms the volume and the structure of the grains in the reservoir rock. Pore fluids are squirted from the high aspect ratio pore interconnections into the pore space. Depending on the viscosity of the pore fluid, this crossflow dissipates part of the energy. The remainder of the energy is stored as potential energy, which is used to restore the rock matrix and the pore fluid to its original state of equilibrium. The time taken to restore to the original state of equilibrium depends on the physical geometry of the pores, pore inter-connections and the viscosity of the pore fluid. This restoration time to recover to the original state can be identified as a ‘time-constant’.

In FIG. 1, the seismic wave 21 that is generated by source 10 is reflected as 22 from the interface of formation 18 and 19. The seismic wave 21 will have very little time-constant since the formation 18 is dry and has no pore fluids. On the other hand, seismic wave 23 that travels through the reservoir formation 31 and is reflected as 24, propagates through the oil-bearing rock, which is porous and permeable. High-viscosity oil as pore fluid will cause the seismic pulse to stretch and have a larger time-constant. The larger time-constant generates lower frequencies that will not be present in dry rock or in the rocks that have lower viscosity pore fluids. The spectrum of the reflected signal 24 will exhibit lower frequencies that are not part of the original input seismic wave. Seismic source 15, located in wellbore 13, transmits a short duration seismic impulse that travels through the rock as 29, which is recorded by the downhole array 16, located in wellbore 12, will provide similar results. The measurement of the relative amplitudes of the lower-frequency content of the reflected signals from the interface of 19 and 20 will characterize the oil-bearing rock and differentiate it from water-bearing rock or dry rock. A larger amplitude of the lower frequencies in the range of 2 Hz to 6 Hz will identify and highlight the oil-bearing rocks, their extent and location. Water-saturated rocks will display a very weak component or absence of these frequencies.

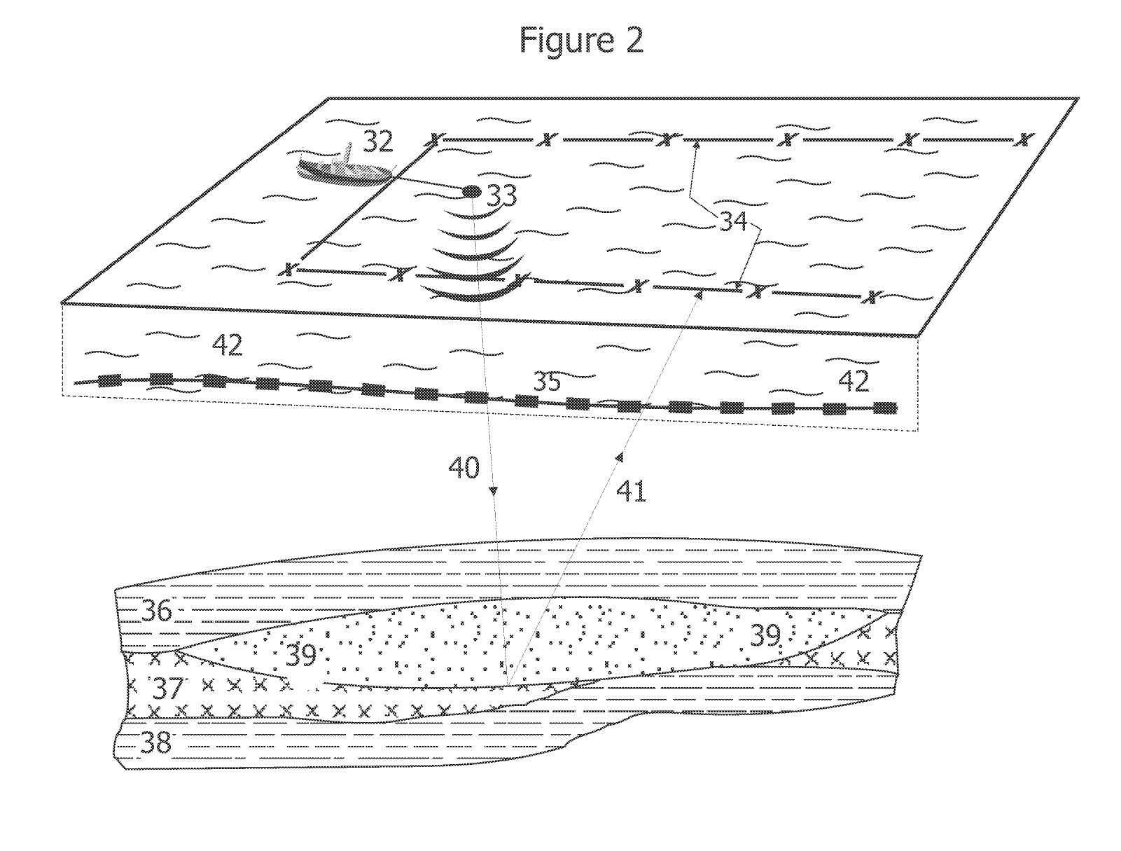

FIG. 2 illustrates data acquisition for this invention in offshore marine operations. There is very little extra requirement for this invention, in addition to what is already available in the industry or is being used as standard practice on a worldwide scale. The main requirement for this invention is to maintain the fidelity of the lower frequencies in the seismic spectrum during the recording process of the seismic reflection data. In the past, frequencies lower than 10 Hz quite often were filtered out while recording field seismic reflection data. However, for this invention, frequencies in the lower part of the seismic spectrum below 10 Hz are used to differentiate the reflections from oil-bearing rocks versus water-bearing rocks. During marine data acquisition, every necessary effort has to be made to preserve and record lower frequencies. However, marine source arrays have to be designed to generate a short duration impulse, which is rich in frequencies above 10 Hz and does not generate a strong signal below 6 Hz. Absence of a 2 Hz to 6 Hz band of frequencies in the source spectrum will make it easier to identify the lower-frequency component being generated in the oil-saturated subsurface formations.

In FIG. 2, 32 is a marine seismic vessel, equipped with marine seismic source 33, towing a number of streamers 34, which are equipped with sensors to record seismic reflected signals. In addition to using towed streamers, the industry also uses ocean-bottom cables to record the seismic reflections like shown as 35. The ocean-bottom cable 35 is laid out at the ocean bottom 42 and is not towed like the streamer 34. Since ocean-bottom cable 35 is stationary, the lower-frequency data acquisition noise is not being generated, providing this method of recording certain advantages over conventional streamer recording. Since marine seismic reflection technology is well understood in the industry, this simplified diagram does not go into a lot of detail. The energy generated by the seismic source 33 is a sharp seismic impulse of short duration and propagates as 40 through the ocean water into subsurface formations 36, 37, 38, and oil-bearing rocks 39. The reflected signals, for simplicity shown as 41, are reflected back from acoustic impedance subsurface boundaries and recorded by the streamer 34 and/or ocean-bottom cable 35. The oil-bearing rocks are shown as 39, which contain pore fluids that have higher viscosity compared to other rocks 36, 37, and 38, which are dry or saturated with water. The short duration seismic compressional impulse generated by the source 33, which could be an air-gun or water-gun, propagates through different subsurface formations including the oil-bearing rocks 39. The seismic pulse during its propagation through 39, compresses its volume and causes the oil to squirt from the pore interconnections into the pore space. This squirt flow process uses a certain amount of energy, part of which is lost as friction and the rest is stored as potential energy in the pore fluid. This potential energy is used to bring the total system of the rock and its pore fluids back to the equilibrium state. This process of pore fluid flowing back to its original state takes a certain amount of time depending on the viscosity of the pore fluid. Oil, being of higher viscosity, requires a longer time to go back to its original equilibrium state after the oil-bearing rock has been disturbed by the seismic pulse generated by 33. This longer time-constant for oil, compared to water as pore fluid, generates lower frequencies that are unique and not generated when the rock is water-saturated, gas-saturated or dry.

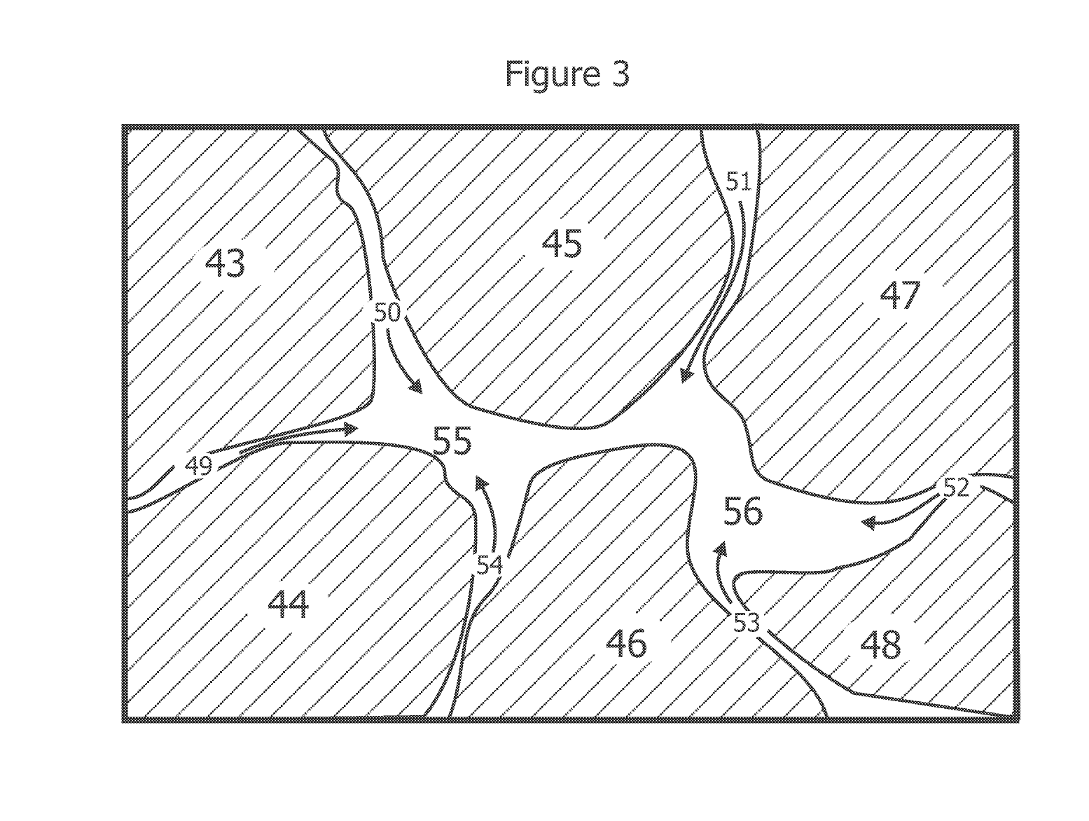

FIG. 3 illustrates the complex structure of the grains in a porous and permeable reservoir rock. The grains 43, . . . , 48 are arranged to have different pore spaces between them as shown by 49, . . . , 56. 55 and 56 are the larger pores that contribute to the major part of the rock porosity. The pore interconnections 49, . . . , 54 are relatively thin and provide the pathways for the permeable fluid flow through the rock. During the propagation of seismic impulse the rock is compressed and the fluid is ejected or squirted out of the thin pore interconnections 49, . . . , 54. The equilibrium state of the reservoir rock is disturbed. Following the compressional seismic pulse, the rock matrix and the pore fluids tends to go back to its original state of equilibrium. However, due to the higher viscosity of the pore fluid (oil), there is friction, which causes hysteresis and time lag. This phenomenon is more pronounced in the case of oil compared to water or gas, since oil exhibits higher viscosity compared to water or natural gas. The propagation of the seismic impulse through the porous, permeable and fluid-saturated reservoir rock, is a coupled motion. So, when the potential energy that is stored in the pore fluid during the compressional cycle is released, as the fluid goes back to its original state of equilibrium, it affects the shape of the seismic impulse in the reservoir rock. In a higher-viscosity pore fluid like oil, it takes a longer time for the pore fluid and the rock matrix to return to its original state of equilibrium compared to water or natural gas. The time-constant for recovery to its original state in the case of higher-viscosity oil is greater compared to the lower viscosity pore fluids. A larger time-constant stretches the seismic pulse and generates lower frequencies, which will not be there in the case of water or natural gas. On a seismic reflection image, this will highlight the reservoir formations that are oil-saturated rather than those reservoir formations that are water-saturated or natural gas-saturated.

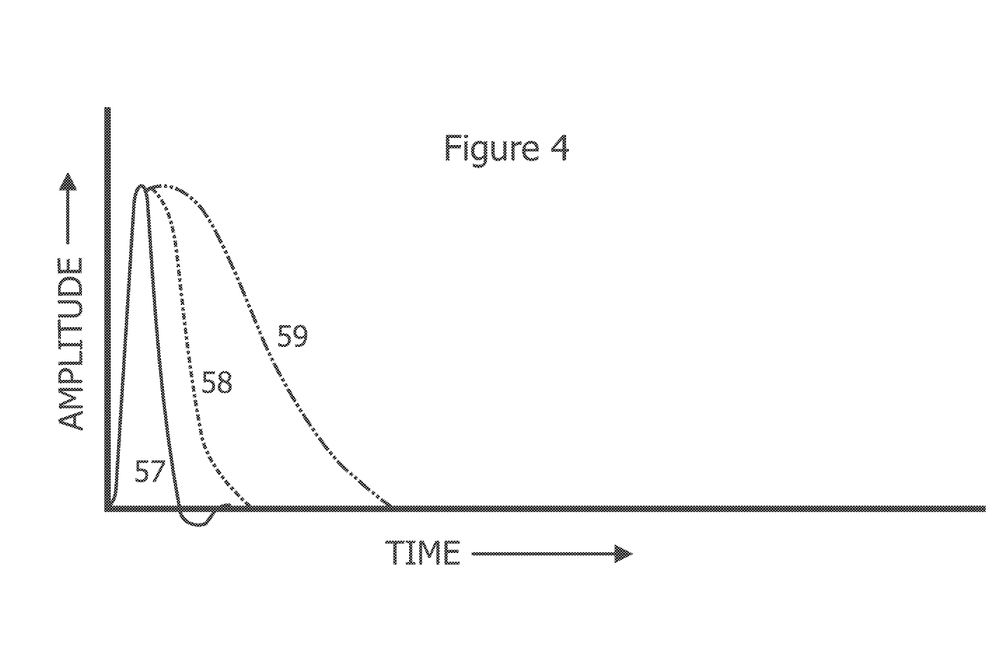

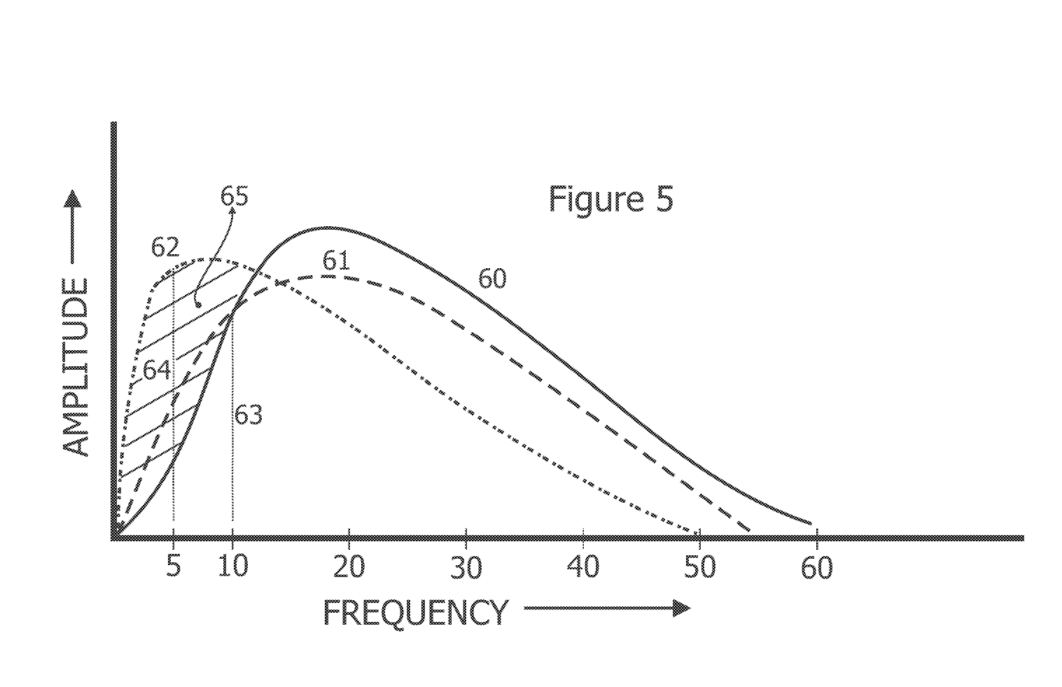

FIG. 4 displays the time-amplitude response of the seismic impulse 57. 58 displays the response of the seismic impulse after it has been modified due to propagation in water-saturated reservoir rock. 59 displays the response of the same impulse after it is modified due to propagation in higher-viscosity oil-saturated reservoir rock. Higher-viscosity pore fluid shows more resistance to the fluid flow; hence, it takes a longer time period for the pore fluids to flow back to their original state of equilibrium after they have been squirted out as a result of the seismic compressional impulse. Any time a seismic pulse is stretched in time, its frequency spectrum is modified and it generates lower frequencies in the seismic spectrum that were not originally part of the seismic input signal. 63 and 64 in FIG. 5 show the relative amplitudes of 10 Hz and 5 Hz, respectively. 65 in FIG. 5 displays the lower-frequency spectrum in the seismic-reflected signal, which is the differentiating characteristic of the oil-bearing rock compared to water-saturated, gas-saturated or dry rock. Mapping the frequencies on the seismic reflection image, shown as 65, highlights the oil-bearing volume of the reservoir rock and is a direct indicator of the presence of oil.

This invention introduces a new method to map and highlight the oil-bearing subsurface formations in comparison with formations that are dry or water-saturated. It uses a seismic short duration impulse as a source for 2D, 3D, or borehole seismic, to perform seismic reflection recording according to the current art. As shown in FIG. 4, the oil-bearing rocks, in response to the seismic impulse, generate a longer time-constant due to their higher viscosity. This longer decay time of the potential energy stored in the high-viscosity pore fluid generates lower frequencies below the 6 Hz in the spectrum of the seismic reflected signal. These frequencies are unique, since they are not part of the originally transmitted seismic signal, but are being created in the oil-bearing reservoir rock. These lower frequencies will not be so prominent in a reservoir rock that is saturated by water or natural gas. The presence of these lower frequencies in the order of 2 Hz to 6 Hz in the seismic reflection indicates the location and the extent of the oil-bearing rock in the subsurface reservoir formation. The exact frequency generated in the oil-bearing rock will be related to the pore structure and the viscosity of the oil present in the formation. In most cases, one would expect frequencies near 4 Hz, plus or minus a few Hertz. During seismic data acquisition and data processing, special care has to be taken to preserve these frequencies and not destroy them due to any sort of filtering process. The knowledge to record and process the seismic data for this invention is currently known and available in the industry. There is also a different type of software readily available in the industry for displaying the 2D or 3D seismic reflection images that can be used to highlight the oil-bearing rocks and locate the presence of oil in the subsurface formations.

FIG. 5 is an illustration of the frequency spectra of the seismic reflected signals when the seismic source input is a short duration impulse. The frequency spectra display the average spectrum of the seismic reflected signals from the dry, water-saturated and oil-saturated subsurface rock formations. The frequency spectrum 60 represents the reflected signals from dry, subsurface rock formations. The frequency spectra 61 and 62 represent reflected signals from water-saturated and oil-saturated rocks, respectively. The frequency spectra shown as 60, 61, and 62 illustrate the differences in the relative amplitudes of the frequencies below 10 Hz. The frequency spectrum shown as 60 represents the average spectrum of the seismic reflections from the dry subsurface formations that have no porosity, permeability or pore fluids. In most cases, seismic reflected signals from dry subsurface formations do not have a strong presence of frequencies below 10 Hz. This absence of lower frequencies in the seismic reflected signals is caused by the lack of strength of the lower frequencies being generated by the seismic sources currently being used. The frequency spectrum shown as 61 displays the average spectrum from a fluid-saturated rock formation that is saturated with lower viscosity pore fluid like water. In the case of water-saturated reservoir rock, a certain amount of lower frequencies are present due to the recovery time shown as 58 in FIG. 4. However, in the case of oil, which has much higher viscosity, the time-constant or the recovery time response to its original state of equilibrium 59, as shown in the FIG. 4, is greater and the seismic pulse is considerably stretched, thus generating a strong component of the lower frequencies as shown by 62, in FIG. 5. This lower-frequency content, as shown by 62, is unique to the oil-saturated rocks since it is generated in the reservoir rock itself and is independent of the seismic input signal. The presence of the lower frequencies in the reflected signal from a particular subsurface rock formation, which are in the order of 2 Hz to 6 Hz, is a strong indicator that the formation is oil-saturated. This will manifest itself as a lower-frequency bright spot on the seismic subsurface reflection image. In this invention, the relative amplitudes of the lower frequencies in the seismic spectrum are used to map the location and the extent of the oil-saturated reservoir formations.

For further analysis of the relative amplitudes of the lower frequencies in a particular seismic horizon of interest, there are many available software algorithms that are readily available and are being used as a routine in the industry today. A time or depth window, which covers the zone of interest, can be analyzed using Fourier Transform or Spectral Decomposition, which will highlight the differences in the relative amplitudes of the lower frequencies in a particular time or depth window to show the exact location and the extent of the oil-bearing subsurface rocks. Any other suitable frequency filtering methods that have been available for many years can be used to show the presence of oil-bearing formations on a seismic reflection cross-section image. This method of mapping oil-bearing subsurface rock formations is valid for all type of seismic (2D, 3D, Borehole, offshore or onshore).

### REFERENCES CITED

Johnson, P. A.; Dynamic Elastic Nonlinearity in Earth Materials. Research Thesis for Doctorate, Paris University, December 1997.

O'Connell, R. J.; Viscoelastic Properties of Fluid-Saturated Cracked Solids. American Geophysical Union, 1977.

Winkler, K., Nur, A.; Pore Fluids and Seismic Attenuation in Rocks. American Geophysical Union, 1979.

Mavko, G. M., Nur, A.; Wave Attenuation in Partially Saturated Rocks. SEG Meeting, 1976.

Dvorkin, J.; Self-Similarity in Rock Physics.

Journal: The Leading Edge, August 2007.

Khan, T. A., Khan McGuire, S.; Elastic Nonlinearity of Reservoir Rocks—A Paradigm Shift;

Journal: CSEG Recorder, May 2005.

Khan, T. A., Khan McGuire, S.; Nonlinear seismic data can improve hydrocarbon recovery from reservoirs;

Journal: Oil & Gas Journal, June 2006.

1. A new method of determining and mapping the presence, location and extent of the oil-bearing reservoir rocks, highlighting their presence in comparison with rocks that are water-saturated or gas-saturated or dry, comprising the steps of:
using reflection seismic recording methods with an impulse-generating source, that transmits a short duration seismic compressional impulse, this signal can be generated on the land surface, marine or shallow water or in a wellbore, the reflected signals from the subsurface formations received by the surface receivers, marine streamers, ocean-bottom cable, downhole receiver arrays or any combination of these and recording the received signals using conventional seismic data acquisition system;
recording 2D, 3D, marine or land seismic, or borehole seismic reflection data using standard recording procedures and processing the recorded data to generate the primary subsurface seismic reflection image, the subsurface image generated by using the current state of the art and standard seismic data processing methods for 2D, 3D, or borehole seismic, methods that are known in the industry, and are used for seismic reflection reservoir imaging;
preserving the total bandwidth of the seismic signal during data acquisition and data processing, with special consideration given to preserving the lower part of the seismic spectrum all the way down to 0 Hz;
displaying the 2D or 3D reflection seismic subsurface images and using currently available software algorithms to enhance and highlight the subsurface formations of interest, which are oil-saturated by using currently known frequency filtering and frequency decomposition methods, preserving the relative amplitudes of the reflected signals with special care to preserve the lower frequencies in the seismic spectrum.

2. The method in claim 1 further comprising:
comparing the relative amplitudes of the reflections from the reservoir formations of interest on each 2D or 3D seismic data volume with more emphasis on the relative amplitudes of the signals in the frequency range around 2 Hz to 6 Hz, the relatively higher amplitudes in the range of 2 Hz to 6 Hz indicative of that particular formation being saturated with higher-viscosity oil compared to lower-viscosity water or natural gas.

3. The method in claim 1 further comprising:
using the lower-frequency seismic images of the subsurface formations to identify the presence, location and the extent of the oil-saturated rocks.

4. The method in claim 1 further comprising:
improving the reliability and reducing the ambiguity of the current seismic results by providing direct oil indication by mapping and highlighting seismic anomalies in the 2D or 3D seismic data volume, anomalies based on relatively higher amplitudes of 2 Hz to 6 Hz seismic reflected signals.
